(19) United States
(12) Patent Application Publication
(10) Pub. No.: US 2023/0316973 A1
(43) Pub. Date: Oct. 5, 2023

(54) Digital/smart furniture

(71) Applicant: Lorenza Binkele, London (GB)

(72) Inventor: Lorenza Binkele, London (GB)

(21) Appl. No.: 14/280,737

(22) Filed: May 19, 2014

(51) Int. Cl. G09G 3/00

(52) U.S. Cl. CPC G09G 3/035; G09G 3/3225

(57) ABSTRACT

A decorational object or piece of furniture wrapped or covered by a flexible screen/s (on which images, videos and data are displayed), connected to an energy and an electronic receptor. By sending information through an electronic device, the decorational object or piece of furniture's appearance will change visually.

### BRIEF SUMMARY OF INVENTION

Furniture or/and decorational object covered/wrapped by flexible/foldable screen (OLED/LED or/and AMOLED or/and Graphene) in order to be able to display images, videos as well as patterns.

### SPECIFICATION

The digital/smart furniture piece or/and decorational object is covered/wrapped by flexible/foldable screen (OLED/LED or/and AMOLED screen/s or/and graphene) and includes an electronic receptor/receiver (with memory function) which receives information, as well as an energy/power source.

It can display information (images, videos, patterns) which are sent from an electronic device such as a mobile, as well as any electronic device (computer, laptop, tablet, etc), through Bluetooth and/or a mobile application (app) or any other emitting image, video, or information function. As soon as the information is received by the digital/smart furniture piece or decorational object (through an electronic receptor), it will display the desired image, videos and/or pattern, creating a new appearance.

The electronic/information receptor will be allocated in a hidden position within or outside the furniture piece where it won't be visible and doesn't interrupt the desired design and appearance.

The energy source to energize the digital/smart furniture is not critical; then it's understood that all types of energy sources can be used. (Solar power, battery, plug—in, etc.) The fastest and most efficient energy source is desired.

The furniture or decorational object/piece can be any size, shape and design. By furniture or decorational objects, all types are meant (tables, chairs, closet, lamps, etc.)

### Other Functions:

If desired the flexible screen can also be touchscreen/s. Additional components would be necessary which would enable the digital/smart furniture piece or decorational object to operate as a touchscreen device such as a touchscreen electronic tablet or mobile.

### How to Use it:

The user selects which image, video or pattern he/she wants to send to the digital/smart furniture piece or decorational object. The flexible screen/s of the piece will now display this selected image, video, etc.

### DESCRIPTION OF THE DRAWINGS/IMAGES

The following images are an example of how the digital/smart furniture piece would look like if it were to be wrapped/covered by foldable/s screen. The shapes and colours of the furniture pieces are infinite therefore following images just serve as an example.

The information receptors, as well as the energy source, are hidden so they don't disturb the design or appearance of the furniture piece.

FIG. 1: Sample of Chair wrapped in flexible/foldable screen with chosen image/pattern

FIG. 2: Sample of table wrapped in flexible/foldable screen with chosen image/pattern

FIG. 3: Sample of lamp wrapped in flexible/foldable screen with chosen image/pattern

FIG. 4: Sample of closet wrapped in flexible/foldable screen with chosen image/pattern

FIG. 5: Sample of armchair wrapped in flexible/foldable screen with chosen image/pattern

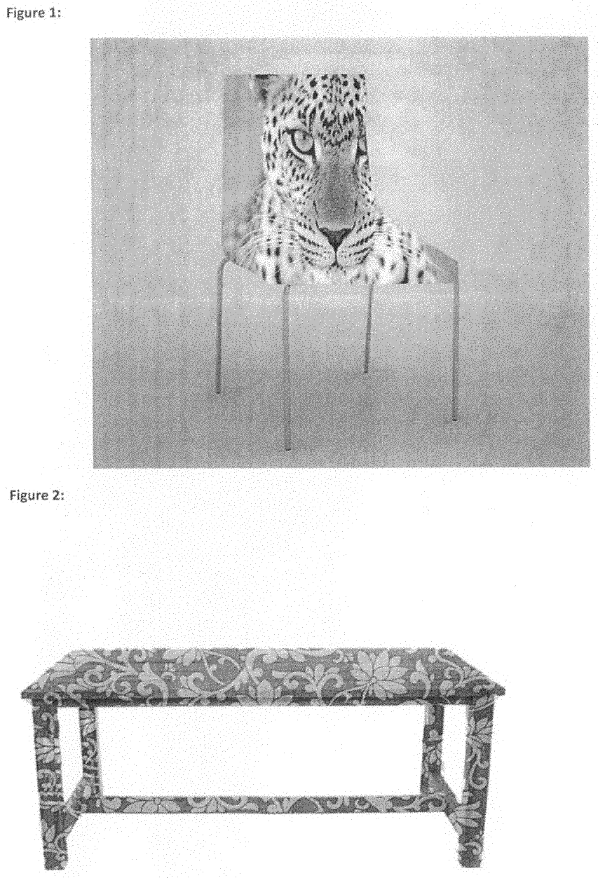

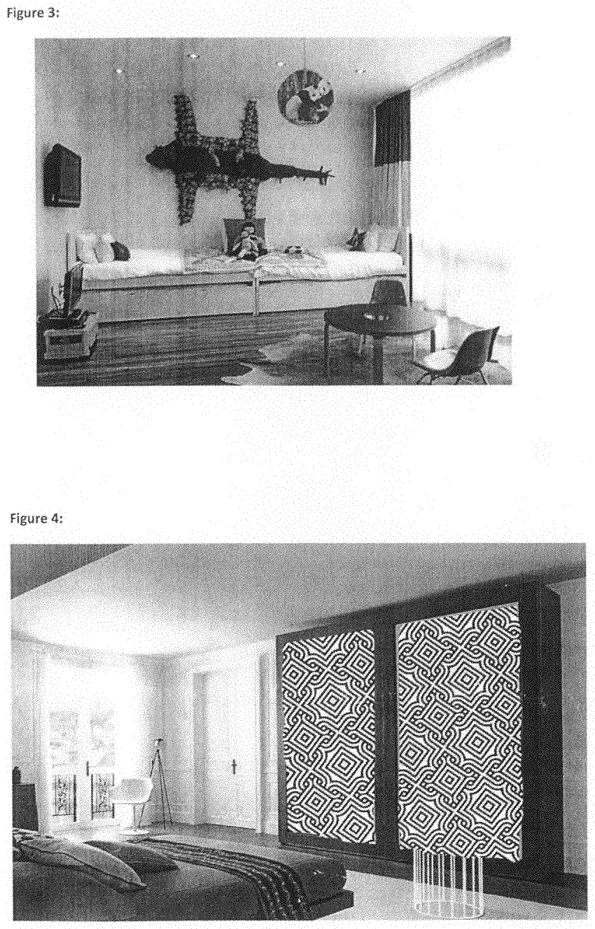

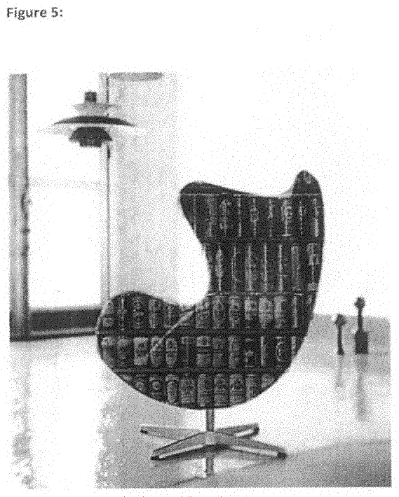

1. A furniture piece, comprising:
(a) A body with an outer surface;
(b) A digital screen configured to be flat or flexible;
(c) A connected electronic receiver of data communication configured to receive visual content via wireless communication;
(d) A power source configured to provide electrical energy to the digital screen; and
(e) A software platform to run from a computing device and from which content can be sent wirelessly to the digital screen.
